(19) United States
(12) Patent Application Publication
(10) Pub. No.: US 2010/0127912 A1
(43) Pub. Date: May 27, 2010

(54) REMOTE CONTROL

(75) Inventors: David J. Rye, Kent, WA (US); James R. Phillips, Bellevue, WA (US)

Correspondence Address: BLACK LOWE & GRAHAM, PLLC, 701 FIFTH AVENUE, SUITE 4800, SEATTLE, WA, 98104, US

(73) Assignee: X-10 LTD., Hunghom, Kowloon (HK)

(21) Appl. No.: 12/324,464

(22) Filed: Nov. 26, 2008

(51) Int. Cl. G08C 19/12

(52) U.S. Cl. 341/176

(57) ABSTRACT

A remote control device having an emitter pointing in a direction generally non-parallel to a plane defined by the buttons. In some versions three emitters are provided, with the emitters pointing in different directions and having different radiation patterns. In additional versions, at least some of the buttons include Braille markings.

### FIELD OF THE INVENTION

This invention relates generally to remote control devices.

### BACKGROUND OF THE INVENTION

Remote control devices are relatively common, and routinely accompany electronic devices such as televisions, stereos, cable television or satellite receiver controllers, digital video disk players, and others. Some devices operate in a radio frequency (RF) band of the frequency spectrum, while other remote controls operate in the infrared (IR) frequency band. Remote controls that operate in the IR band generally require the IR emitting device (such as a light emitting diode, or LED) to be pointed in the direction of the electronic device, with no obstructions between the remote control and the device. Although some IR remote controls will operate sporadically by bouncing a signal off a wall or other object in order to reach the electronic device, an IR remote works best when there is a direct and unobstructed line of sight between the LED and the electronic device.

Unfortunately, the requirement for such a direct path between the remote and the electronic device is further complicated in that the LED in remote controls is placed such that it points in a direction lying parallel to the plane on which the buttons are placed. As a consequence, the remote is often pointed upward, toward the ceiling, when a person is looking at the remote in order to press the proper buttons to change a channel or perform another such operation. Especially for those with poor vision, this can often result in entering commands into the remote that have no effect at all on the electronic device because the signal never makes it to the electronic device.

### SUMMARY OF THE INVENTION

A preferred version of the invention is illustrated in the figures and described in greater detail below. In accordance with the preferred version, the remote control includes more than one emitter such as an LED, with the emitters pointing in different directions. In one version, at least a first emitter points in a direction parallel to the plane in which the buttons are placed, with at least a second additional emitter being orthogonal to the plane in which the buttons are placed (and therefore generally orthogonal to the first emitter). In other versions, the second emitter is non-parallel to the first emitter, but not necessarily orthogonal.

In other versions, a third emitter is included, the third emitter pointing in a direction generally parallel to the first emitter but having a different radiation pattern. For example, the first emitter may be configured with a narrow but distant pattern while the third emitter may be configured with a wide but short pattern.

In some versions, the buttons on the remote further include Braille on or adjacent the buttons to facilitate use of the remote controller by one with impaired vision.

In additional versions, the remote may be configured to be much larger than a standard remote, and in one example it is about 10 cm wide and 22 cm long.

These and other examples of the invention will be described in further detail below.

### BRIEF DESCRIPTION OF THE DRAWINGS

Preferred and alternative examples of the present invention are described in detail below with reference to the following drawings:

FIG. 1 is a front view of a remote in accordance with an example of the invention;

FIG. 2 is an end view of the remote of FIG. 1; and

FIG. 3 is a back view of the remote of FIG. 1.

### DETAILED DESCRIPTION OF THE PREFERRED EMBODIMENT

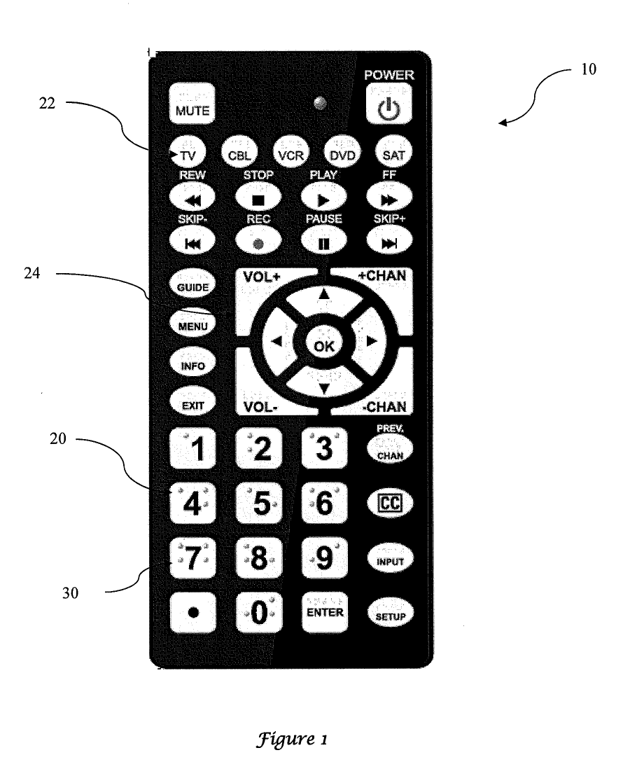

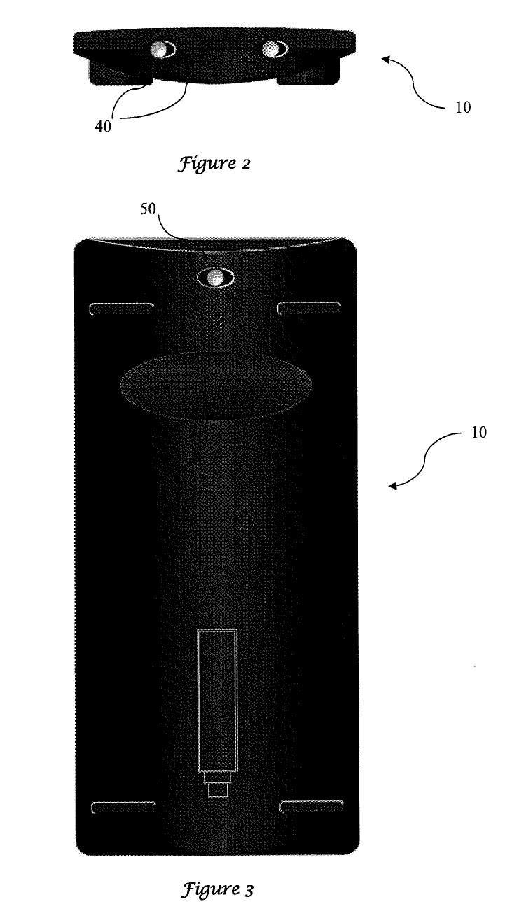

A preferred remote is shown in FIGS. 1-3. As seen in FIG. 1, the remote 10 includes a case having a front side with a plurality of buttons. A back side (best seen in FIG. 3) of the case opposes the front side, and in general the back side includes an outer surface substantially parallel to the outer surface of the front side. A top end joins the front side to the back side (as best seen in FIG. 2). As shown, the buttons are in the form of raised buttons that can be mechanically depressed to initiate an action, though in other versions the buttons can be an indicated area on a touch screen that need not necessarily be represented in the shape of a button.

The buttons on the remote may be configured to serve any of a variety of functions. For example, a set of numbered buttons 20 preferably includes a separate button for each of the digits 0 through 9. Another region of the remote includes control buttons 24, such as buttons to increase or decrease the volume, or to increment or decrement the current channel. Additional function buttons 22 may include a series of device select buttons for indicating which one of a plurality of electronic devices the remote control is to command. As shown, the remote control includes such select buttons for controlling a television (TV), a cable set-top box (CBL), a videocassette recorder (VCR) a digital video disk player (DVD), and a satellite dish controller (SAT). The remote may further have any of a plurality of other function buttons, such as power, mute, menu, guide, info, and exit buttons. Specific control buttons such as rewind, stop, play, fast forward, skip forward/back, record, and pause may also optionally be included, with such buttons most typically used with controlling recorded media devices. Still additional buttons such as previous channel, closed caption, input, enter, and setup may also be provided.

Internally, the remote control includes a power supply such as a battery and electronics sufficient to cause the controller to transmit a signal to a remote electronic device in response to commands entered by depressing the buttons. The internal components may be complicated and include a microprocessor, memory, and programming instructions that allow for complex control functions and allow the remote to be programmed to perform a series of tasks. Alternatively, the remote control may be less sophisticated and include less complex internal circuitry. In either event, the internal circuitry couples the buttons to the emitter, causing the emitter to illuminate and thereby transmit an appropriate signal corresponding to the button inputs.

In some versions, one or more of the buttons include raised Braille markings 30. In the specific version as shown, each of the plurality of buttons on the remote includes a Braille marking. In other versions, only a subset of the buttons may include such Braille markings. In yet other versions, the remote control may include Braille markings adjacent the buttons, for example just above or just below the buttons, as is most appropriate.

Some examples of the preferred remote also include a remote casing that is larger than a typical remote control. In an example version, the remote has a length (defined in the direction parallel to the numbers 1, 4, 7 on the keypad) and a width (defined in a direction parallel to the numbers 7, 8, 9 on the keypad), with the length being about 22 centimeters and the width being about 10 centimeters. In such a version, many of the buttons are greater than 1 square centimeter in size.

The remote control includes at least one IR emitter, and as shown the IR emitter is in the form of a light emitting diode (LED). A typical IR remote control includes one LED located at the top end of the remote such that LED radiates in a direction lying generally in a plane parallel to that formed by the buttons. In the preferred version, as best seen in FIG. 2, two emitters 40 are provided, with both emitters pointing in the same direction—away from the remote in a direction parallel to the plane of the front face of the remote (and more particularly, in a direction parallel to the length of the remote).

Though only one such emitter would be sufficient, in the preferred version two emitters are used, with each one of the two emitters being configured differently. Thus, one of the emitters is configured to have a radiation pattern that is relatively narrower but more distant than the other, and the other of the two emitters is configured to have a radiation pattern that is relatively shorter but wider than the first. The combination produces a broader coverage area than the use of one emitter alone.

In addition to the first two emitters 40 (or instead of the two emitters, in some embodiments), the preferred remote includes a third emitter 50. The third emitter is configured to direct its radiating light in a plane that is non-parallel with the direction of radiation of either of the first two emitters 40, and most preferably in a direction that is approximately orthogonal to the plane defined by the buttons and the front surface of the remote control. In some versions, the remote may include a fourth emitter, with the fourth emitter being directed in the same plane as the third emitter but the third and fourth emitter being configured to have different radiation patterns, as with the first and second emitters.

The use of the emitters as described above allows a user to enter commands in the remote without pointing the top end of the remote toward the television or other electronic device. This configuration allows a user to hold the remote in a more natural way, with the remote pointed in a more upward direction so that the user can see the buttons while pushing them. Likewise, the combined emitters allows the sight impaired users to more successfully operate a remote electronic device with the remote even if it is not pointed accurately at the device.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A remote controller for controlling an electronic device, comprising:
a case having a front side, a back side, and an end defining an internal cavity;
a plurality of buttons configured on the front side of the case, the plurality of buttons defining a plane;
a first emitter extending externally to the case, the first emitter pointing in a direction non-parallel to the plane; and
transmitter circuitry within the internal cavity, the transmitter circuitry being configured to cause the first emitter to illuminate in response to commands entered via at least one of the plurality of buttons.

2. The remote controller of claim 1, wherein the first emitter is pointing substantially orthogonal to the plane.

3. The remote controller of claim 1, further comprising a second emitter, the second emitter pointing in a direction substantially parallel with the plane.

4. The remote controller of claim 3, further comprising a third emitter, the third emitter pointing in a direction substantially parallel to the second emitter.

5. The remote controller of claim 4, wherein the second emitter comprises a radiation pattern that is relatively wider than a radiation pattern of the third emitter.

6. The remote controller of claim 5, wherein the first emitter is pointing substantially orthogonal to the plane.

7. The remote controller of claim 6, wherein at least one of the plurality of buttons includes Braille indicators.

8. The remote controller of claim 7, wherein each of the plurality of buttons includes Braille indicators.

9. The remote controller of claim 7, the remote controller further comprising a length and a width, wherein the length is greater than about 20 cm and the width is greater than about 20 cm.

10. The remote controller of claim 1, wherein at least one of the plurality of buttons includes Braille indicators.

11. The remote controller of claim 10, wherein each of the plurality of buttons includes Braille indicators.

12. A remote controller for controlling an electronic device, comprising:
a case having a front side and an opposing back side defining an external surface and an internal cavity;
a plurality of buttons configured on the external surface of the case;
a first emitter being configured to transmit infrared light external to the case, the first emitter pointing in a first direction; and
a second emitter being configured to transmit infrared light external to the case, the second emitter pointing in a second direction, the second direction being non-parallel to the first direction.

13. The remote controller of claim 12, wherein the first direction is substantially orthogonal to the first direction.

14. The remote controller of claim 13, further comprising a third emitter, the third emitter being configured to transmit infrared light external to the case, the third emitter pointing in a third direction, the third direction being substantially parallel to the second direction.

15. The remote controller of claim 14, wherein the first direction is substantially orthogonal to the first direction.

16. The remote controller of claim 15, wherein the second emitter comprises a radiation pattern that is relatively wider than a radiation pattern of the third emitter.

17. The remote controller of claim 16, wherein at least one of the plurality of buttons includes Braille indicators.

18. The remote controller of claim 16, wherein each of the first, second, and third emitters comprise light emitting diodes.
